(19) United States
(12) Patent Application Publication
(10) Pub. No.: US 2026/0121962 A1
(43) Pub. Date: Apr. 30, 2026

(54) DYNAMIC ACTIVATION OF NETWORK TROUBLESHOOTING AGENT HOSTING

(71) Applicant: Cisco Technology, Inc., San Jose, CA (US)

(72) Inventors: Jean-Philippe Vasseur, Combloux (FR); Grégory Mermoud, Venthône (CH); Eduard Schornig, Haarlem (NL); Pierre-André Savalle, Rueil-Malmaison (FR)

(73) Assignee: Cisco Technology, Inc., San Jose, CA (US)

(21) Appl. No.: 18/929,929

(22) Filed: Oct. 29, 2024

(51) Int. Cl. H04L 43/16; H04L 41/0604; H04L 41/0677

(52) U.S. Cl. CPC H04L 43/16; H04L 41/0627; H04L 41/0677

(57) ABSTRACT

In one implementation, a device determines network latency metrics associated with one or more user endpoints in a network accessing a remote language model-based network troubleshooting agent via the network. The device makes a determination that the network latency metrics exceeds a threshold. The device selects a node in the network between the one or more user endpoints and the remote language model-based network troubleshooting agent to execute a local language model-based network troubleshooting agent. The device configures the node to process troubleshooting requests from the one or more user endpoints using its local language model-based network troubleshooting agent in lieu of sending the troubleshooting requests to the remote language model-based network troubleshooting agent.

### TECHNICAL FIELD

The present disclosure relates generally to the dynamic activation of network troubleshooting agent hosting.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

However, implementing a network troubleshooting agent that uses an LLM to perform its tasks remains challenging because of the latencies involved and the potential that users of the troubleshooting system could perceive its response time as being unacceptable. These latencies generally take two forms: 1.) the processing time of the agent itself (e.g., the time needed for the agent to process the LLM tokens, to retrieve information regarding the networking devices in the network, etc.) and 2.) the latency of the network when conveying a request to the agent from a user endpoint and returning its response. When running the troubleshooting system in a data center, the network latency is typically negligible compared to the processing time of the agent. In contrast, the network latency may be far from negligible if the user endpoint is located in a remote branch and could impact the overall experience of the user.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example software defined network (SDN) implementation;

FIG. 5 illustrates an example architecture for using a large language model (LLM)-based troubleshooting agent in a computer network;

FIG. 6 illustrates the operation of an LLM-based network troubleshooting agent;

FIG. 7 illustrates an example architecture for the dynamic activation of network troubleshooting agent hosting; and

FIG. 8 illustrates an example simplified procedure for the dynamic activation of network troubleshooting agent hosting.

### DESCRIPTION OF EXAMPLE IMPLEMENTATIONS

### Overview

According to one or more implementations of the disclosure, a device determines network latency metrics associated with one or more user endpoints in a network accessing a remote language model-based network troubleshooting agent via the network. The device makes a determination that the network latency metrics exceeds a threshold. The device selects a node in the network between the one or more user endpoints and the remote language model-based network troubleshooting agent to execute a local language model-based network troubleshooting agent. The device configures the node to process troubleshooting requests from the one or more user endpoints using its local language model-based network troubleshooting agent in lieu of sending the troubleshooting requests to the remote language model-based network troubleshooting agent.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

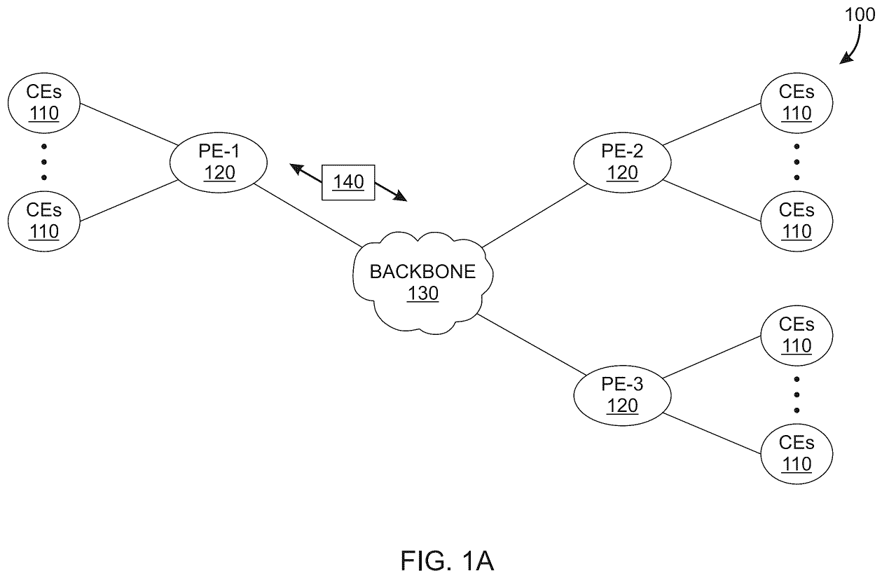

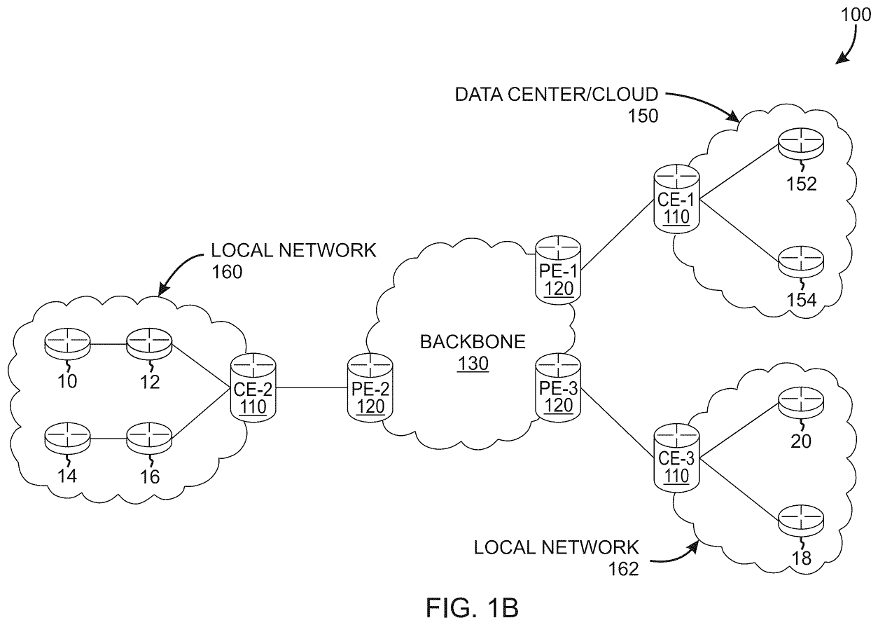

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

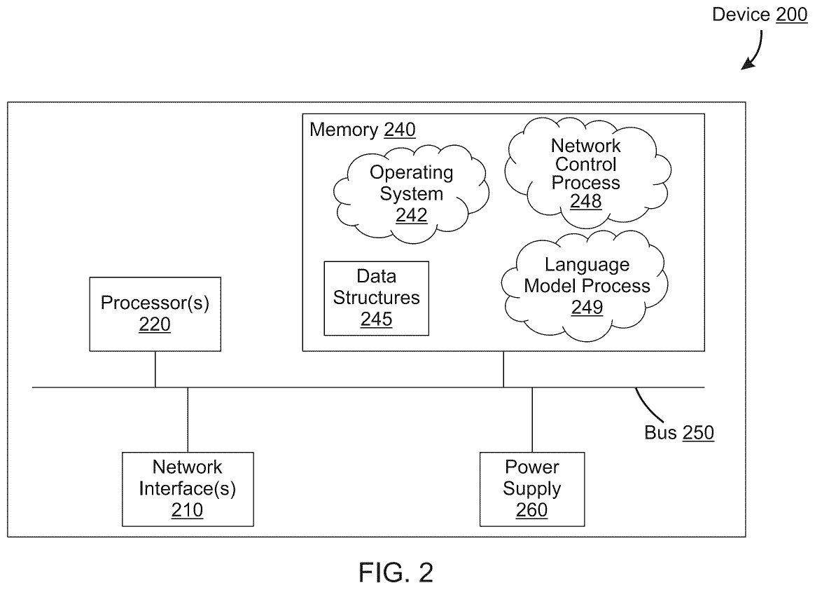

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a network control process 248 and/or a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In some instances, network control process 248 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, network control process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, network control process 248 and/or language model process 249 may include computer executable instructions that, when executed by processor(s) 220, cause device 200 to perform the techniques described herein. To do so, in some implementations, network control process 248 and/or language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, network control process 248 and/or language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network control process 248 and/or language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, network control process 248 and/or language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, network control process 248 may use a generative model to generate synthetic network traffic based on existing user traffic to test how the network reacts. Example generative approaches can include, but are not limited to, generative adversarial networks (GANs), large language models (LLMs), diffusion models, other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

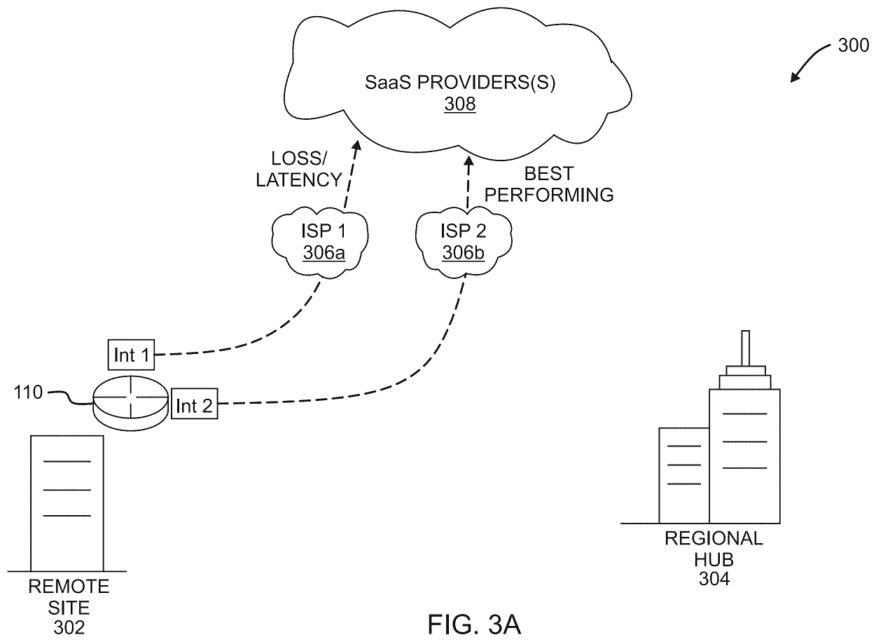

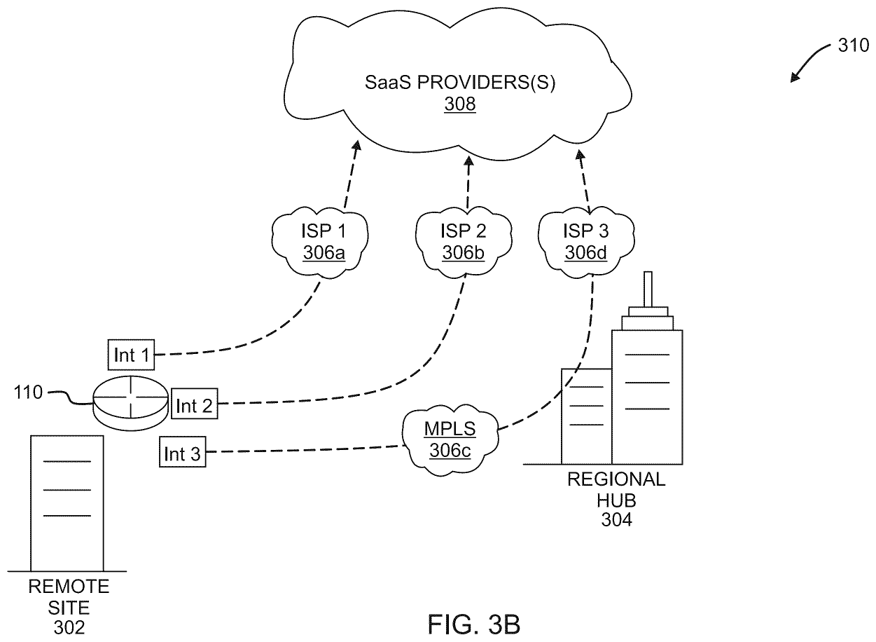

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

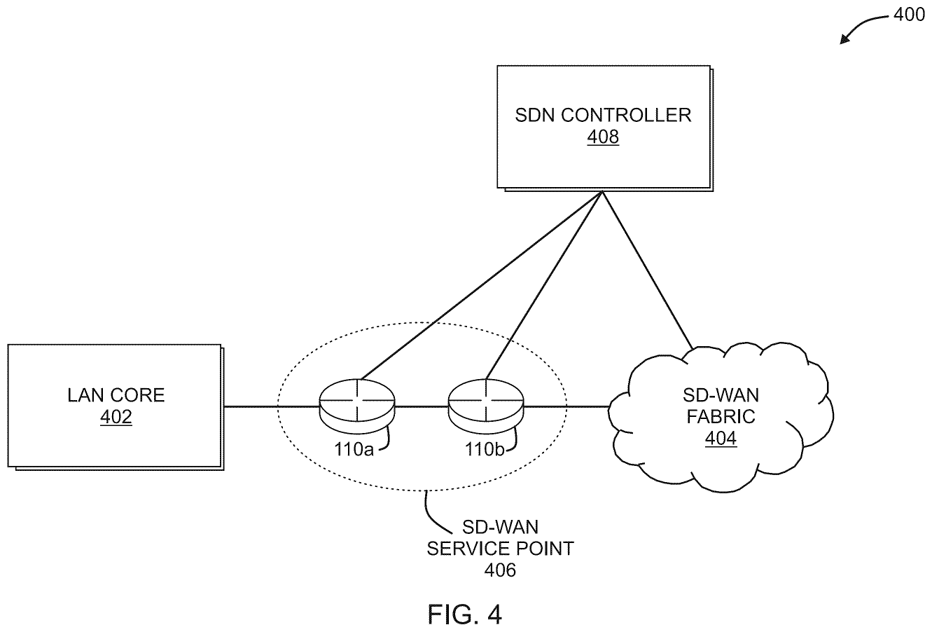

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service (e.g., through execution of network control process 248), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address. For instance, SDN controller 408 may make use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, SDN controller 408 may compute a variety of models to understand application requirements, and predictably route traffic over private networks and/or the Internet, thus optimizing the application experience while drastically reducing SLA failures and downtimes.

In other words, SDN controller 408 may first predict SLA violations in the network that could affect the QoE of an application (e.g., due to spikes of packet loss or delay, sudden decreases in bandwidth, etc.). In other words, SDN controller 408 may use SLA violations as a proxy for actual QoE information (e.g., ratings by users of an online application regarding their perception of the application), unless such QoE information is available from the provider of the online application. In turn, SDN controller 408 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one implementation. In general, routing configuration changes are also referred to herein as routing “patches,” which are typically temporary in nature (e.g., active for a specified period of time) and may also be application-specific (e.g., for traffic of one or more specified applications).

As noted above, the recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc.

In the specific context of computer networks, though, network troubleshooting and monitoring are traditionally complex tasks that rely on engineers analyzing telemetry data, configurations, logs, and events across a diverse array of network devices encompassing access points, firewalls, routers, and switches managed by various types of network controllers (e.g., SD-WAN, DNAC, ACI, etc.). Moreover, network issues can manifest in various forms, stemming from a multitude of factors, each with its own level of complexity.

The introduction of plugins is a major development that enables LLM-based agents to interact with external systems and empower new domain-specific use cases. In the context of communication networks, the utilization of plugins allows LLMs to engage with documentation repositories, tap into knowledge bases, and interface with live network controllers and devices potentially opening the path to LLMs undertaking more complex tasks such as on-demand troubleshooting, device configuration, and performance monitoring. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

However, building a user-facing product from an LLM-based agent can be difficult for reasons such as the following:
An agent flow to answer a question may require multiple steps, each of which can take some time, individually. Consequently, the system may take a noticeable amount of time to provide an answer to the original question (e.g., on the order of minutes), which can be frustrating to users.
LLMs can make mistakes which may not be apparent to a user. For example, consider the case of an LLM that can generate code that calls an API to list network devices but somehow provides an incorrect filter argument to the API. When the API returns an empty result set, a user may interpret this result as meaning that no devices match their desired criteria while, in fact, the system simply called the API incorrectly. These issues can be hard to avoid due to the opaque and non-deterministic nature of LLMs, and users may quickly lose confidence in the system when faced with such issues.
Although LLMs can provide an alternative user experience by allowing a user to ask questions about a system using natural language, users often have years of familiarity with traditional web or application user interfaces. A chatbot can feel like a disconnected experience from those user interfaces, which can also be frustrating to users.

The techniques herein introduce an LLM-based troubleshooting and monitoring agent that can be used to both troubleshoot an issue and trigger a set of actions in order to solve the issue. In some implementations, several conditions could be met for an issue to be eligible to self-healing, such as the criticality of the issues (determined by the volume of request sent to a bot for that issue). Various mechanisms are then used to determine whether the set of actions led to the resolution of the issue. Successful resolutions are then used to record successful troubleshooting trajectories and thus improve the training of the agent.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein, such as in conjunction with network control process 248.

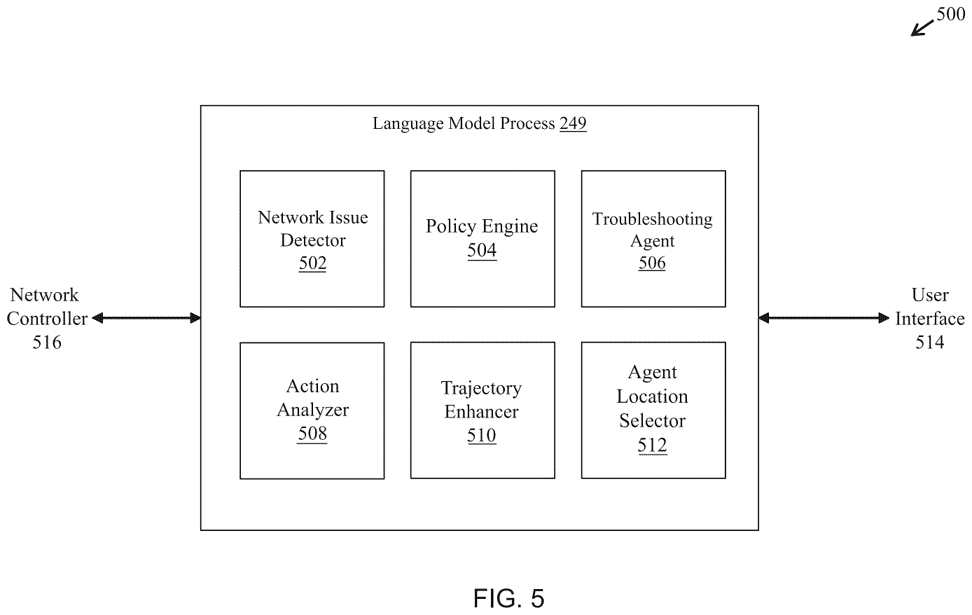

Operationally, FIG. 5 illustrates an example architecture 500 for using a large language model (LLM)-based troubleshooting agent in a computer network, according to various implementations. At the core of architecture 500 is language model process 249, which may be executed by a controller for a network or another device in communication therewith. For instance, language model process 249 may be executed by a controller for a network (e.g., SDN controller 408 in FIG. 4, a network controller in a different type of network, etc.), a particular networking device in the network (e.g., a router, a firewall, etc.), another device or service in communication therewith, or the like. For instance, as shown, language model process 249 may interface with a network controller 516, either locally or via a network, such as via one or more application programming interfaces (APIs), etc.

As shown, language model process 249 may include any or all of the following components: a network issue detector 502, a policy engine 504, a troubleshooting agent 506, an action analyzer 508, a trajectory enhancer 510, and/or an agent location selector 512. As would be appreciated, the functionalities of these components may be combined or omitted, as desired. In addition, these components may be implemented on a singular device or in a distributed manner, in which case the combination of executing devices can be viewed as their own singular device for purposes of executing language model process 249.

During execution, network issue detector 502 may detect an issue in a network and assess its criticality. To do so, network issue detector 502 may employ any number of modes for the issue detection. In one case, network issue detector 502 may explicitly list the set of issues eligible for self-healing functionality (e.g., detection of a link/router down, congestion thresholds for a given link layer, trigger of a recovery mechanism such as IGP/FRR, automated network tests or probes failing). In another case, network issue detector 502 may detect an issue based on information from a (troubleshooting) bot receiving requests from a set of users, in which case the issue can be created on-the-fly, if the number/rate of requests related to (a specific type of) issue exceeds a given threshold (e.g., via a chatbot).

Once network issue detector 502 has detected an issue I, it may then determine the criticality of that issue. To that end, one option may consist in checking the number of potential users who raised a similar issue that share the same root cause according to the root causing process initiated by troubleshooting agent 506, as described below, or its LLM may also be used to determine whether the issues raised by the users have a common root cause. In other cases, an LLM may determine criticality based on the number of impacted systems or applications or the volume of affected network traffic.

Policy engine 504 is used to configure which issues identified by network issue detector 502 are eligible for LLM-based self-healing capabilities. Indeed, despite the potential power of self-healing networks, the effective use of dynamic closed-loop control is subject to debate. Consequently, some administrators are ready to adopt closed-loop control with no human in the loop wherever and whenever possible, whereas others do mandate the presence of a human to perform any action in the network, sometimes such decisions are even driven by regulations. To this end, policy engine 504 allows a network administrator to specify policies to selectively enable or disable the self-healing capabilities of the system with respect to certain types of issues.

For example, a network administrator may specify via policy engine 504 (e.g., using a user interface 514) the set of applications eligible to for self-healing resolution and/or whether a minimum number of users per application type is required to automatically trigger closed-loop control according to troubleshooting agent 506. Further constrains can be defined for governing in which parts of the network (specific sites) or on which types of devices troubleshooting agent 506 is allowed is allowed to attempt remediation actions. For example, a network administrator may allow troubleshooting agent 506 to initiate the reboot of a wireless access point, while restricting the same action on a core router or central firewall.

According to various implementations, troubleshooting agent 506 may leverage one or more LLMs to troubleshoot an issue identified by policy engine 504, find the actual root cause for the issue, and/or suggest a set of one or more actions to fix the issue. Let ai denote an action used for troubleshooting an issue I and let Ai denote an action (configuration change) on the network (closed-loop control). The set of actions Ai required to solve the issue I may be determined on-the-fly by an LLM, statically determined according to a cookbook for each trajectory made of a set of action ai, or the like. For example, a static cookbook may be used to map a specific ak to set of actions Ak,l. Consider the action ak=“Check the priority queue length of a router,” a static set of action ak,l may be used to trigger a set of l action on the network (e.g., “Change the weight of the priority queue,” “Modify the WRED parameter for the high priority queue”). In another implementation, the system may discover the set of required actions related to a given root cause identified thanks to a set of action ai, using reinforcement learning or another suitable approach.

If the root cause identified for issue I is eligible for self-healing action (according to policy engine 504), troubleshooting agent 506 may perform any or all of the following:
Troubleshooting agent 506 retrieves the set of action Ai for the root cause of issue I after activating a timer T (max time to solve the issue)
Troubleshooting agent 506 may also employ various optimization criterion may be used for solving a given task T. For instance, troubleshooting agent 506 may solve some tasks with objective metrics such as reducing the processing time or improve accuracy even at the risk of involving more steps and tokens (cost). In the context of the techniques herein, the issue criticality from network issue detector 502 may also drive the optimization criteria (time versus reliability versus cost). In one implementation, the optimization criteria may be unique and decided according to policy and criticality. In another implementation, troubleshooting agent 506 may trigger multiple actions in parallel, each with different optimization criterion. For example, for a given issue I, troubleshooting agent 506 may send a request to a first LLM with a first criteria (e.g., solve as quickly as possible, optimizing time) and send the same request to a second LLM with different optimization criteria (e.g., efficiency). In such a case, troubleshooting agent 506 may use the reply to the first request (set of resolution action Ai) to quickly fix the network, followed by using the second set of actions to optimize the resolution of the issue. Note that both requests may not overlap in terms of closed-loop actions, as well.

Action analyzer 508 may assess whether the set of actions triggered by troubleshooting agent 506 have actually solved the issue. To that end several approaches may be used:
The LLM may itself ask to the users who had originally expressed some concerns whether the issue has been remediated.
The agent may check the various set of actions ai along the debugging trajectories whether the conditions that were used to identify the issues have been cleared. For example, back to the previous example, the system may check the high priority queue length and determine whether the action (change the weight) has solved the issue.

In some implementations, trajectory enhancer 510 is used to enhance the set of successful trajectories. As would be appreciated, troubleshooting agent 506 represents a complex troubleshooting and monitoring mechanism that may be based on one or more LLMs, a local database, and other components. On receiving a question, troubleshooting agent 506 may form a prompt after retrieving a set of “information” from a local database and triggers a set of actions ai (i.e., code snippet used to retrieve information from APIs, etc.) until an answer to the question is provided.

In this context, a “trajectory” refers to a set of successive actions ai triggered by troubleshooting agent 506 according to the LLM input. In some instances, trajectory enhancer 510 may use the trajectories to train one or more of the LLMs to perform similar troubleshooting tasks, stored as recipes (set of successful actions, etc.). For instance, action analyzer 508 may flag an action as successful if the answer from troubleshooting agent 506 satisfies a set of characteristics for a given (manual crafted) scenario.

In some instances, trajectory enhancer 510 may also function as a “troublemaker,” generating issues and then requesting that troubleshooting agent 506 solve them, knowing the answer to the question, beforehand. Thanks to the techniques herein, knowing whether an issue has been solved can be told by determining whether the issue has been solved (an even stronger assumption than in the case of finding a known root cause). Thus, each time the issue is solved by triggering one of more action Ai that solves the issue I, the corresponding trajectory is marked as successful and the list of action ai can be added to the database of successful trajectories.

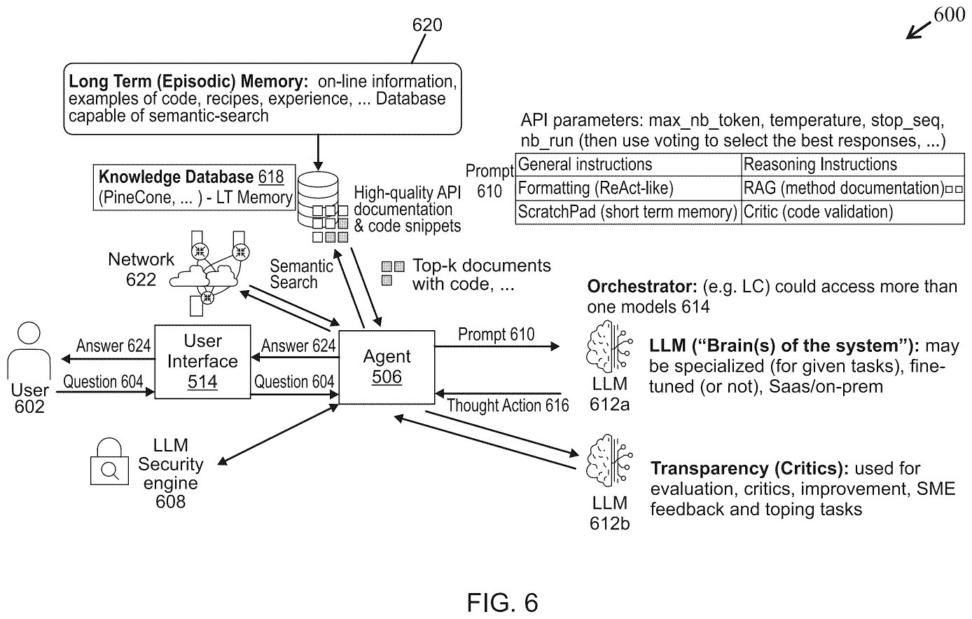

FIG. 6 illustrates an example 600 showing the operation of an LLM-based troubleshooting agent 506 performing self-healing actions in a network 622, according to various implementations. As shown, troubleshooting agent 506 may interact with one or more LLMs 612, such as LLMs 612a-612b shown, to perform self-healing actions in a network 622. These LLMs may be integrated directly into troubleshooting agent 506 or accessed by troubleshooting agent 506 remotely, such as via an API. In some implementations, each of these LLMs may have different capabilities, as well. For instance, LLM 612a may a 0-shot or model trained using Low-Rank Adaptation of LLMs (LoRA), whereas LLM 612b may be a fine-tuned model (e.g., using T5 with LoRA, knowledge distillation, etc.) with decoding lop access for constrained prompting. In some instances, troubleshooting agent 506 may also leverage an intermediary orchestrator 614 that can access one or more of the LLMs, such as LLM 612a and LLM 612b.

In further cases, LLM 612b may be a critic model that is used to critique any outputs of LLM 612a. For instance, say that LLM 612a generates code to perform a certain task (e.g., to retrieve certain information from a network controller or other entity). In such a case, LLM 612b may assess the quality of the code (e.g., to make sure it is not missing information, correctly calls a certain method or API, is able to perform the desired task, etc.). Feedback from LLM 612b can then be fed back to LLM 612a, to enhance its operations.

Assume now that a user 602 enters a question 604 via user interface 514 regarding network 622. Note that while such input typically takes the form of a question, mere statements such as “my network connection is slow, etc.” are also equally possible inputs. In turn, troubleshooting agent 506 may seek to answer question 604 by interacting with network 622, interacting with a knowledge database 618 populated by a long term (episodic) memory 620 (e.g., by performing a semantic search for API formats, code snippets, recipes, sample use cases, or the like) using retrieval augmented generation (RAG) and/or by issuing a prompt 610 for input to any of LLMs 612. Note that prompt 610 may also indicate general instructions and/or reasoning instructions, to obtain information regarding an action 616. In some instances, an LLM security engine 608 may also oversee the actions of troubleshooting agent 506, to prevent conditions such as prompt injection attacks, etc.

In some cases, troubleshooting agent 506 may also implement action 616 in network 622. For instance, troubleshooting agent 506 may send a command to a network controller of network 622 (e.g., via an API) to reconfigure the network to address any issues. In turn, troubleshooting agent 506 may provide an answer 624 back to user interface 514 to answer question 604 (e.g., “your connection was slow because of a misconfiguration—please let us know if the issue has been resolved,”etc.).

As noted above, one challenge with respect to implementing the network troubleshooting and monitoring system described above is that the latencies involved from the standpoint of a user may lead to poor user experience. These latencies generally take two forms: 1.) the processing time of the agent itself (e.g., the time needed for the agent to process the LLM tokens, to retrieve information regarding the networking devices in the network, etc.) and 2.) the latency of the network when conveying a request to the agent from a user endpoint and returning its response. When running the troubleshooting system in a data center, the network latency is typically negligible compared to the processing time of the agent. In contrast, the network latency may be far from negligible if the user endpoint is located in a remote branch and could impact the overall experience of the user.

### Dynamic Activation of Network Troubleshooting Agent Hosting

According to various implementations, the techniques herein allow for the dynamic activation of a network troubleshooting agent on a node closer to the user endpoint(s), thereby reducing the network latency, as well as the overall latency of which the network latency is a component. In some aspects, the techniques herein introduce the following functionalities: 1.) each networking gear is dynamically discovered along with their ability to host a troubleshooting agent, 2.) a deep packet inspection (DPI)-enabled agent hosted on premise that determine whether users in the network would experience unacceptable response time because of high network latency, and 3.) a controller (or distributed algorithm) that determines whether a local (potentially less capable) agent can be hosted locally in the network and closer to the user endpoint(s), thus intercepting local request and consequently positively impacting the response time. Such a decision may be governed according to the reduction of the response time in light with the potential efficacy degradation of using local, less-capable models.

Specifically, according to various implementations, a device determines network latency metrics associated with one or more user endpoints in a network accessing a remote language model-based network troubleshooting agent via the network. The device makes a determination that the network latency metrics exceeds a threshold. The device selects a node in the network between the one or more user endpoints and the remote language model-based network troubleshooting agent to execute a local language model-based network troubleshooting agent. The device configures the node to process troubleshooting requests from the one or more user endpoints using its local language model-based network troubleshooting agent in lieu of sending the troubleshooting requests to the remote language model-based network troubleshooting agent.

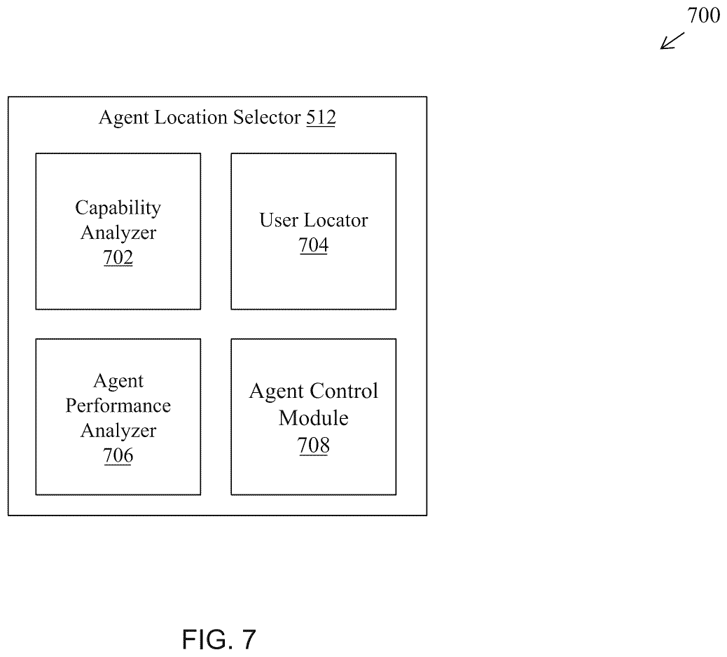

FIG. 7 illustrates an example architecture for the dynamic activation of network troubleshooting agent hosting. As the core of architecture 700 is agent location selector 512, which may include any or all of the following sub-components: a capability analyzer 702, a user locator 704, an agent performance analyzer 706, and/or an agent control module 708. As would be appreciated, the functionalities of these sub-components may be combined or omitted, as desired. In addition, they may also be executed on a singular device or in a distributed manner, in which case the set of executing devices may be viewed as a singular device for purposes of the teachings herein.

In various implementations, capability analyzer 702 may be responsible for discovering the topology of the network and the capabilities of its nodes (e.g., routers, switches, etc.). To do so, may access an API or otherwise interface with a network controller (e.g., vAnalytics and Meraki for example). Alternatively, capability analyzer 702 may do so by establishing a routing adjacency over a tunnel to an existing router running a link-state routing protocol such as ISIS (with overload bit set) or OSPF.

The second part of the discovery is used to determine potential resources on-premise (on routers and switches) available to host troubleshooting agent 506. In such cases, capability analyzer 702 may use one of various approaches, such as those highlighted in the Internet Engineering Task Force (IETF) Request for Comments (RFC) 7770 entitled “Extensions to OSPF for Advertising Optional Router Capabilities,” RFC 7981 entitled “IS-IS Extensions for Advertising Router Information,” and RFC 5492 entitled “BGP Router Capabilities (BGP Capabilities Advertisement).” In such cases, the nodes may advertise their agent-related capabilities such as the amount of resources that a node has available (memory, CPU, etc.) to host troubleshooting agent 506. In yet another implementation, such node capabilities may be advertised by the controllers, such as network controller 516.

In some implementations, user locator 704 may determine where users (and their endpoints) are located in the network and the contribution of network latency to response time of the troubleshooting system. To that end, user locator 704 may make use of deep packet inspection (DPI) to detect when a user endpoint sends a request to a remote troubleshooting agent 506 (e.g., hosted in the cloud, in a data center, etc.), as well as the response time of the system.

In general, agent performance analyzer 706 may assess whether the response time associated with the remote troubleshooting agent 506 exceeds a certain value Rmax (considered as the maximum response time tolerable for the user). If so, agent performance analyzer 706 may trigger path probing to the remote troubleshooting agent 506, to determine whether the system response time is due to network latency (Lat) or the remote troubleshooting agent 506. If Lat/Response time>R (e.g., a threshold), then this means that the excessive response time is mostly due to network latency and agent performance analyzer 706 may notify agent control module 708 of this condition. In some instances, agent performance analyzer 706 may only send such a notification when the number of users exceeds a threshold Tu.

In various implementations, agent control module 708 may be responsible for enabling or disabling a troubleshooting agent 506 on a node in the local network of the user endpoint(s) to process their prompts/requests in lieu of the remote troubleshooting agent 506. In some instances, agent control module 708 may do so when certain conditions are met, such as when a threshold number of users Tu that experience high response time (>Rmax) mostly because of high network latency. In some instances, agent control module 708 may interact with the remote troubleshooting agent 506 to select the model candidate for use by the local troubleshooting agent 506 (according to the resources advertised by the hosting node). One strategy may be to select the most capable remote troubleshooting agent 506 that matches the available resources.

As this point, the selected node may intercept all requests initiated by users for the remote troubleshooting agent 506 (e.g., using DPI) and process them locally using the local troubleshooting agent 506, while also monitoring the total response time for the user (latency is then minimum). The local engine is also responsible for monitoring for each request the response time (which may be increased compared to the one of a more capable system previously hosted in the data center) and the corresponding efficacy. Indeed, using a lighter locally hosted troubleshooting agent 506 may help improve the responsive at the cost of a potential lower efficacy (since the system/model may be lighter and thus less capable). Once the local agent is active, the system may continue to explore by redirecting some request using an Epsilon-greedy approach.

In further implementations, the system may take a mixed approach where some requests are processed locally by the local troubleshooting agent 506, whereas others may be relayed to another troubleshooting agent 506 capable of reducing the response time (e.g., an agent that closer to the remote/datacenter-hosted troubleshooting agent 506) while being optionally more capable than a lighter one. To that end, an addition extension is specified where nodes hosting troubleshooting agent 506 also advertise their performance (efficacy) per type of request. Thus, agent control module 708 may indicate to each node the set of remote nodes along with their respective efficiency thus allowing each node to evaluate the tradeoff between response time and efficacy. In yet another embodiment, a local troubleshooting agent 506 may try to process a request and, in case of failure, it may decide to relay to a second node also hosting another troubleshooting agent 506, should its efficacy be advertised as significantly higher.

Agent location selector 512 may also be configured to disable any of the troubleshooting agent 506, such as any of those hosted by a node in the same local network as that of the suer endpoints. In one instance, agent control module 708 may remote system in absence of sufficient user request of excessive failure rate (e.g., the efficacy of a local troubleshooting agent 506 is too low) according to some user specified threshold. Such decisions may also be entirely distributed, in further implementations.

By way of example, agent control module 708 may determine that node X1 should try to process all requests and only relay to X2 (also hosting a troubleshooting agent 506), if the failure rate of the local troubleshooting agent 506 on X1 exceeds a given value.

In another example, agent control module 708 may determine that if the number of requests on a given node hosting a local troubleshooting agent 506 falls below a given value, the agent on that node should be disabled.

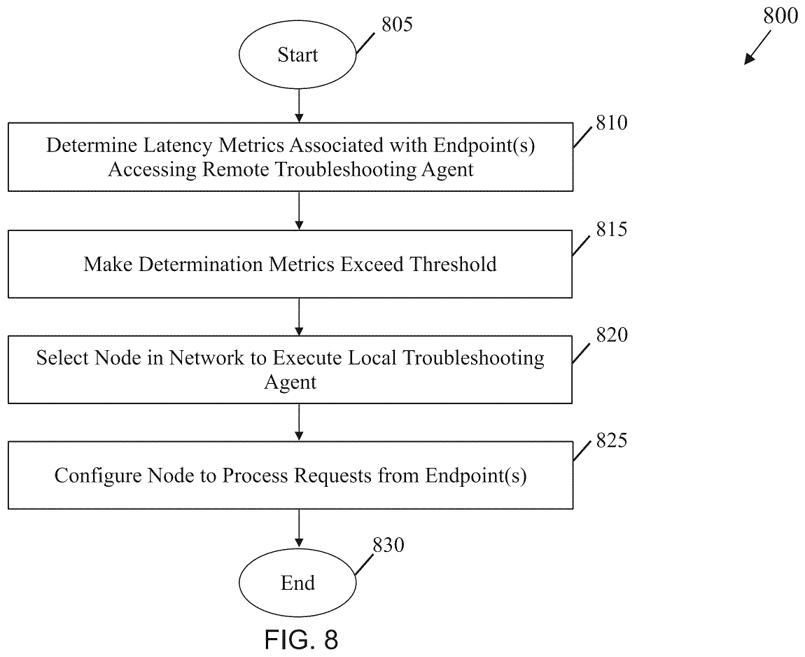

FIG. 8 illustrates an example simplified procedure 800 (e.g., a method) for the dynamic activation of network troubleshooting agent hosting, in accordance with one or more implementations described herein. For example, a non-generic, specifically configured device (e.g., device 200), such as a router, firewall, controller for a network (e.g., an SDN controller or other device in communication therewith), server, or the like, may perform procedure 900 by executing stored instructions (e.g., language model process 249 and/or network control process 248). The procedure 800 may start at step 805, and continues to step 810, where, as described in greater detail above, the device may determine network latency metrics associated with one or more user endpoints in a network accessing a remote language model-based network troubleshooting agent via the network. In various implementations, the remote language model-based network troubleshooting agent uses a large language model (LLM) to troubleshoot issues in the network. In some instances, the remote language model-based network troubleshooting agent has a higher efficacy than that of the local language model-based network troubleshooting agent executed by the node.

At step 815, as detailed above, the device may make a determination that the network latency metrics exceeds a threshold. Such a threshold may be predefined, set via a user interface by an administrator, or adjusted dynamically, in various instances.

At step 820, the device may select a node in the network between the one or more user endpoints and the remote language model-based network troubleshooting agent to execute a local language model-based network troubleshooting agent, as described in greater detail above. In various implementations, the node comprises a router or switch in the network. In some cases, the device selects the node based in part on network location information associated with the one or more user endpoints. In a further implementation, the device selects the node in part based on one or more network latency metrics between the node and the one or more user endpoints.

At step 825, as detailed above, the device may configure the node to process troubleshooting requests from the one or more user endpoints using its local language model-based network troubleshooting agent in lieu of sending the troubleshooting requests to the remote language model-based network troubleshooting agent. In various implementations, the one or more user endpoints send the troubleshooting requests towards the remote language model-based network troubleshooting agent and the node intercepts the troubleshooting requests for local processing by the local language model-based network troubleshooting agent. In some implementations, the node sends at least one of the troubleshooting requests to a second node in the network for processing by a language model-based network troubleshooting agent hosted locally by the second node. In one implementation, the node sends at least one of the troubleshooting requests to the second node based on a determination that a failure rate associated with the local language model-based network troubleshooting agent exceeds a failure threshold. In one implementation, the device may also disable the node from using its local language model-based network troubleshooting agent to process the troubleshooting requests, based on a number of the troubleshooting requests dropping below a given value.

Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for the dynamic activation of network troubleshooting agent hosting, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
determining, by a device, network latency metrics associated with one or more user endpoints in a network accessing a remote language model-based network troubleshooting agent via the network;
making, by the device, a determination that the network latency metrics exceeds a threshold;
selecting, by the device, a node in the network between the one or more user endpoints and the remote language model-based network troubleshooting agent to execute a local language model-based network troubleshooting agent; and
configuring, by the device, the node to process troubleshooting requests from the one or more user endpoints using its local language model-based network troubleshooting agent in lieu of sending the troubleshooting requests to the remote language model-based network troubleshooting agent.

2. The method as in claim 1, wherein the remote language model-based network troubleshooting agent uses a large language model (LLM) to troubleshoot issues in the network.

3. The method as in claim 1, wherein the node comprises a router or switch in the network.

4. The method as in claim 1, wherein the device selects the node based in part on network location information associated with the one or more user endpoints.

5. The method as in claim 1, wherein the one or more user endpoints send the troubleshooting requests towards the remote language model-based network troubleshooting agent, and wherein the node intercepts the troubleshooting requests for local processing by the local language model-based network troubleshooting agent.

6. The method as in claim 1, wherein the node sends at least one of the troubleshooting requests to a second node in the network for processing by a language model-based network troubleshooting agent hosted locally by the second node.

7. The method as in claim 6, wherein the node sends at least one of the troubleshooting requests to the second node based on a determination that a failure rate associated with the local language model-based network troubleshooting agent exceeds a failure threshold.

8. The method as in claim 1, wherein the remote language model-based network troubleshooting agent has a higher efficacy than that of the local language model-based network troubleshooting agent executed by the node.

9. The method as in claim 1, further comprising:
disabling, by the device, the node from using its local language model-based network troubleshooting agent to process the troubleshooting requests, based on a number of the troubleshooting requests dropping below a given value.

10. The method as in claim 1, wherein the device selects the node in part based on one or more network latency metrics between the node and the one or more user endpoints.

11. An apparatus, comprising:
one or more network interfaces;
a processor coupled to the one or more network interfaces and configured to execute one or more processes; and
a memory configured to store a process that is executable by the processor, the process when executed configured to:
determine network latency metrics associated with one or more user endpoints in a network accessing a remote language model-based network troubleshooting agent via the network;
make a determination that the network latency metrics exceeds a threshold;
select a node in the network between the one or more user endpoints and the remote language model-based network troubleshooting agent to execute a local language model-based network troubleshooting agent; and
configure the node to process troubleshooting requests from the one or more user endpoints using its local language model-based network troubleshooting agent in lieu of sending the troubleshooting requests to the remote language model-based network troubleshooting agent.

12. The apparatus as in claim 11, wherein the remote language model-based network troubleshooting agent uses a large language model (LLM) to troubleshoot issues in the network.

13. The apparatus as in claim 11, wherein the node comprises a router or switch in the network.

14. The apparatus as in claim 11, wherein the apparatus selects the node based in part on network location information associated with the one or more user endpoints.

15. The apparatus as in claim 11, wherein the one or more user endpoints send the troubleshooting requests towards the remote language model-based network troubleshooting agent, and wherein the node intercepts the troubleshooting requests for local processing by the local language model-based network troubleshooting agent.

16. The apparatus as in claim 11, wherein the node sends at least one of the troubleshooting requests to a second node in the network for processing by a language model-based network troubleshooting agent hosted locally by the second node.

17. The apparatus as in claim 16, wherein the node sends at least one of the troubleshooting requests to the second node based on a determination that a failure rate associated with the local language model-based network troubleshooting agent exceeds a failure threshold.

18. The apparatus as in claim 11, wherein the remote language model-based network troubleshooting agent has a higher efficacy than that of the local language model-based network troubleshooting agent executed by the node.

19. The apparatus as in claim 11, wherein the process when executed is further configured to:
disable the node from using its local language model-based network troubleshooting agent to process the troubleshooting requests, based on a number of the troubleshooting requests dropping below a given value.

20. A tangible, non-transitory, computer-readable medium storing program instructions that cause a device to execute a process comprising:
determining, by the device, network latency metrics associated with one or more user endpoints in a network accessing a remote language model-based network troubleshooting agent via the network;
making, by the device, a determination that the network latency metrics exceeds a threshold;
selecting, by the device, a node in the network between the one or more user endpoints and the remote language model-based network troubleshooting agent to execute a local language model-based network troubleshooting agent; and
configuring, by the device, the node to process troubleshooting requests from the one or more user endpoints using its local language model-based network troubleshooting agent in lieu of sending the troubleshooting requests to the remote language model-based network troubleshooting agent.
